(19) United States
(12) Patent Application Publication
(10) Pub. No.: US 2013/0263960 A1
(43) Pub. Date: Oct. 10, 2013

(54) PIPE SYSTEM FOR CONDUCTING HIGHLY FLAMMABLE LIQUIDS

(71) Applicants: AFT AUTOMOTIVE GMBH & CO. KG, Nordwalde (DE); A. SCHULMAN GMBH, Kerpen (Sindorf) (DE)

(72) Inventors: Hermann CICHOREK, Gieboldehausen (DE); Andreas MAERTEN, Noerten-Hardenberg (DE); Dirk KRAMER, Havixbeck OT Hohenholte (DE); Thilo STIER, Niederkassel (DE); Peter SEBOE, Frankfurt am Main (DE)

(21) Appl. No.: 13/856,902

(22) Filed: Apr. 4, 2013

(30) Foreign Application Priority Data
Apr. 5, 2012 (DE) 10 2012 007 031.4

(51) Int. Cl. F16L 9/14

(52) U.S. Cl. CPC F16L 9/14
USPC 138/140; 29/428

(57) ABSTRACT

A pipe system for the conducting of highly flammable liquids and method for making the pipe system. The pipe system includes at least one tubular conducting element having an inner pipe and an outer casing surrounding the inner pipe. The inner pipe and the outer casing respectively include a plastic, and the outer casing has a flame protection durability of 3 minutes at 600° C. and of 2 minutes at 800° C.

### CROSS-REFERENCE TO RELATED APPLICATIONS

The present application claims priority under 35 U.S.C. §119 of German Patent Application No. 10 2012 007 031.4 filed Apr. 5, 2012, the disclosure of which is expressly incorporated by reference herein in its entirety.

### BACKGROUND OF THE INVENTION

1. Field of the Invention

The invention relates to a pipe system for conducting highly flammable liquids having at least one tubular conducting element, which has an inner pipe and an outer casing surrounding the inner pipe.

2. Discussion of Background Information

Pipe systems of this type serve to conduct, e.g., fuels, such as gasoline and the like. For this, the pipe systems must meet various demands. They must be diffusion-tight with respect to hydrocarbons. Furthermore, they must have a high aging resistance and be usable within a large temperature range. For the transport of the highly flammable liquids, it is naturally extremely important that the pipe system have a high flame protection durability.

Usually, metallic conducting elements are used. In order to achieve a sufficient aging resistance of conducting elements of this type, relatively high-grade metals are necessary. This leads to metallic conducting elements being relatively expensive. At the same time, metal concerns a relatively heavy material, such that the conducting elements are also relatively heavy. When used in mobile units, such as, e.g., in automobiles, a weight reduction is normally desired for improving efficiency.

### SUMMARY OF THE INVENTION

Embodiments of the invention are directed to supplying a pipe system for the conducting of highly flammable liquids, which can serve as a replacement for the previously used pipe systems having metallic conducting elements.

According to the embodiments of the invention, a pipe system of the type discussed at the outset includes an inner pipe and an outer casing respectively having or comprising plastic. The outer casing has a flame protection durability of 3 minutes at 600° C. and of 2 minutes at 800° C.

Thus, instead of using metallic conducting elements as in the known art, conducting elements are used, which, according to embodiments of the invention, comprise a plastic. Therefore, it is possible to manufacture the conducting elements more easily and more cost-effectively. The necessary flame protection durability is achieved by the outer casing, which is coated onto the inner pipe. Both the inner pipe and the outer casing can include a polyamide material. However, these can be different polyamide materials. For the outer casing, good mechanical properties at high temperatures are necessary, as well as a high glass transition temperature and a melting point of at least 150° C. While the outer casing essentially serves as flame protection, the inner pipe serves to give mechanical form and must have a sufficient chemical resistance to the liquids. At the same time, it must be diffusion-tight. A material usable for the outer casing is known by the designation “Invision HT”, which was developed by the co-applicant A. Schulman GmbH.

Preferably, no materially bonded connection is embodied or formed between inner pipe and outer casing. The outer casing can, e.g., by adhesive bond or frictional fit or by positive fit, be retained on the inner pipe. Further, connections are not necessary. Movements between the outer casing and the inner pipe can occur, e.g., for different temperature expansions of the outer casing and the inner pipe, such that no impermissibly high tensions develop. At the same time, there is a relatively free choice of materials used for the inner pipe and outer casing, since the inner pipe and outer casing do not have to enter a positive bond. Also, the coating of the outer casing onto the inner pipe can be realized relatively cost-effectively and energy-efficiently.

Preferably, the inner pipe is embodied or formed as a multilayer pipe. Thus, in the inner pipe, a relatively high number of different properties can be combined. An inner layer must be as chemically resistant as possible. The same layer or an additional layer can serve as a diffusion barrier. For supplying the necessary mechanical stability, an additional layer can be used. In this manner, it is favorable if one layer is made of a weldable material, in order to be able to produce welded connections to further conducting elements or coupling elements. As far as possible, the layers should enter a materially bonded connection among one another, in order to achieve a high stability.

Preferably, the plastic of the outer casing is uncrosslinked and has in particular an amorphous polymer material. Through a structure of this type, a very high glass transition temperature is obtained. In this way, a sufficiently high flame protection durability can be achieved.

Preferably, the outer casing has a wall thickness of at least 1 mm and, in particular, at least 1.5 mm. With a wall thickness of 1 mm or 1.5 mm, it is normally ensured that the demands in terms of flame protection durability are met. For increased demands, a greater wall thickness can be used, e.g., 2, 2.5 or 3 mm. If cost and weight play a role, the wall thickness should not be too large, e.g., between 1.5 mm and 2 mm. It is thereby advantageous if the wall thickness of the outer casing is greater than a wall thickness of the inner pipe. In this manner, the total thickness of the conducting element does not become excessively large without this possibly having influences on the flame protection durability.

Preferably, the outer casing has a lower Shore hardness and a higher impact toughness than the inner pipe. Thus, there results a good compromise regarding the resistance to mechanical influences.

Preferably, the Shore hardness of the outer casing lies between Shore A 50 and Shore D 50. A material of this type is sufficiently able to resist mechanical influences and can at the same time be produced with a good flame protection durability.

Preferably, the outer casing has a weldable plastic material. It is thereby possible to connect the outer casing by a material bond to additional conducting elements or coupling elements and thus obtain a stressable connection.

In a preferred embodiment, the outer casing has an additive crosslinkable by irradiation. With the aid of electron radiation, an activation of the additive is possible, which leads to a crosslinking of the material of the outer casing. Through a crosslinking of this type, there results an increased rigidity and a higher melting point.

Preferably, an additional outer layer is arranged on the outer casing. This outer layer can be, e.g., a braiding, a metal or a filler material. Through this outer layer, a geometric or/and optical customization can be achieved, as well as an improvement of the mechanical stability of the pipe system.

In a preferred embodiment, the pipe system has a coupling element which is connected to the conducting element. The coupling element has an inner component and a coating. A material composition of the coating corresponds to a material composition of the outer casing.

In this manner, it is guaranteed that also the coupling element has a sufficiently high flame protection durability. The inner component can likewise comprise a plastic. The entire pipe system then offers sufficient safety for the transport of highly flammable liquids.

Preferably, the inner component is welded to the inner pipe and the coating is welded to the outer casing. Between the coupling element and the conducting element, a double plastic welding so to speak is provided. In this way, a connection that is mechanically extremely stressable is produced, which at the same time is absolutely liquid-tight and diffusion-tight. Not only a closed inside of the pipe system is obtained, but also a closed outside, such that the connection points do not cause a reduction of the flame protection durability.

Embodiments of the instant invention are directed to a pipe system for the conducting of highly flammable liquids. The pipe system includes at least one tubular conducting element having an inner pipe and an outer casing surrounding the inner pipe. The inner pipe and the outer casing respectively include a plastic, and the outer casing has a flame protection durability of 3 minutes at 600° C. and of 2 minutes at 800° C.

According to embodiments, no materially bonded connection is embodied between inner pipe and outer casing.

In accordance with other embodiments, the inner pipe can be formed as a multilayer pipe.

According to still other embodiments, the plastic of the outer casing may be uncrosslinked. Further, the uncrosslinked plastic can be an amorphous polymer material.

In embodiments, the outer casing can have a wall thickness of at least 1 mm. Further, the outer casing may have a wall thickness of at least 1.5 mm.

In other embodiments, the outer casing can have a lower Shore hardness and a higher impact toughness than the inner pipe. The Shore hardness of the outer casing can be between Shore A 50 and Shore D 50.

According to further embodiments of the invention, the outer casing can have a weldable plastic material.

In accordance with still other embodiments, the outer casing may have an additive crosslinkable by irradiation.

In further embodiments, at least one additional outer layer can be arranged on the outer casing.

In still other embodiments, a coupling element may e connected to the conducting element,. The coupling element can have an inner component and a coating, and a material composition of the coating may correspond to a material composition of the outer casing. The inner component can be welded to the inner pipe and the coating is welded to the outer casing.

Embodiments of the invention are directed to a method of forming a pipe connection system. The method includes forming a conducting element by inserting an outer casing over an inner pipe. The inner pipe and the outer casing respectively comprise a plastic, and the outer casing has a flame protection durability of 3 minutes at 600° C. and of 2 minutes at 800° C.

According to embodiments of the invention, the inner pipe and the outer casing is not positively connected.

In accordance with other embodiments, the method can also include forming a coupling element having an inner component and a coating, and connecting the coupling element to the conducting element. A material composition of the coating can correspond to a material composition of the outer casing. The connecting of the coupling element to the conducting element may include welding the inner component to the inner pipe and welding the coating is welded to the outer casing.

In accordance with still yet other embodiments of the present invention, the plastic of the outer casing can include an amorphous polymer material.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a pipe system with a conducting element and a coupling element in schematic view; and

FIG. 2 illustrates a sectional view of the pipe system shown in FIG. 1.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

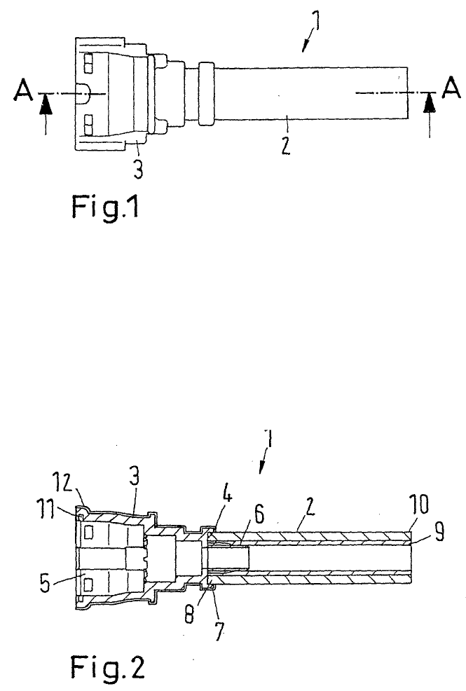

In FIG. 1, a pipe system 1 for the conducting of fluids is shown, in which a tubular conducting element 2 is connected to a coupling element 3. Conducting element 2 and coupling element 3 are formed from or comprise plastic and are welded to one another.

Conducting element 2 is embodied or formed cylinder-shaped and bears against a front face 4 of the coupling element 3 (see FIG. 2). On an end of coupling element 3 facing away from front face 4, an insertion region 5 is provided, in which, e.g., a plug can be inserted.

Starting from front face 4, coupling element 3 has a tubular projection 6 which extends into an inside of conducting element 2. Thus, tubular projection 6 provides a large contact surface that, at the same time, enables a stable mechanical connection between coupling element 3 and conducting element 2. In this way, projection 6 bears against an inside of conducting element 2.

A collar 7 which likewise starts from front face 4 runs parallel to projection 6. Collar 7 is radially spaced from projection 6 and bears against an outside of conducting element 2. When matched with coupling element 2, an end 8 of conducting element 2 is externally covered by collar 7, covered on a front face by front face 4 and covered internally by projection 6. Thus, this arrangement results in a mechanically stable and very tight connection with a relatively large contact surface between conducting element 2 and coupling element 3.

Conducting element 2 includes an inner pipe 9 and an outer casing 10. Outer casing 10 surrounds the inner pipe 9 in a circumferential direction. Outer casing 10 can be non-positively retained, e.g., via shrink fitting or being shrunk onto inner pipe 9. However, outer casing 10 can also have been simply slid in an axial direction onto inner pipe 9, in such a manner that no high retention forces act between inner pipe 9 and outer casing 10. In this manner, a materially bonded connection is not provided.

Coupling element 3 has an inner component 11 and a coating 12. Inner component 11 can be or include a same material as inner pipe 9. Coating 12 can be formed from or include a same material as outer casing 10.

Coating 12 is welded to outer casing 10 and inner component 11 is simultaneously welded to inner pipe 9. This therefore concerns or results in a 2-component to 2-component welding, which guarantees a very high safety.

The material of outer casing 10 and of coating 12 in this exemplary embodiment is an uncrosslinked, amorphous polymer, which has a high flame protection durability of 3 minutes at 600° C. and of 2 minutes at 800° C. In this embodiment, a wall thickness of 1 to 2 mm is sufficient, in particular, approximately 1.5 mm.

Inner pipe 9 and thus the inner component 11 can also have a polyamide which has a lower flame protection durability. For inner pipe 9 and inner component 11, a chemical resistance and diffusion blockability is instead necessary.

An exemplary embodiment is shown in which inner pipe 9 has only a single layer. However, inner pipe 9 can also be structured in a multilayered manner for achieving the desired properties.

Similarly, it is possible that additional layers are applied to outer casing 10, e.g., metallic layers, in order to enable an electric conductivity, or layers for mechanical reinforcement, such as, e.g., braidings or the like.

Between outer casing 10 and inner pipe 9, no or at least no high retention forces need act. A materially bonded connection is therefore not necessary. Instead, inner pipe 9 and outer casing 10 are retained in position to one another by coupling element 3, since outer casing 10 is welded to coating 12 and inner component 11 is welded to inner pipe 9. In this manner, the production of conducting element 2 can occur with very little cost.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pipe system for the conducting of highly flammable liquids comprising:
at least one tubular conducting element having an inner pipe and an outer casing surrounding the inner pipe,
wherein the inner pipe and the outer casing respectively comprise a plastic, and
wherein the outer casing has a flame protection durability of 3 minutes at 600° C. and of 2 minutes at 800° C.

2. The pipe system according to claim 1, wherein no materially bonded connection is embodied between inner pipe and outer casing.

3. The pipe system according to claim 1, wherein the inner pipe is formed as a multilayer pipe.

4. The pipe system according to claim 1, wherein the plastic of the outer casing is uncrosslinked.

5. The pipe system according to claim 4, wherein the uncrosslinked plastic is an amorphous polymer material.

6. The pipe system according to claim 1, wherein the outer casing has a wall thickness of at least 1 mm.

7. The pipe system according to claim 6, wherein the outer casing has a wall thickness of at least 1.5 mm.

8. The pipe system according to claim 1, wherein the outer casing has a lower Shore hardness and a higher impact toughness than the inner pipe.

9. The pipe system according to claim 8, wherein the Shore hardness of the outer casing is between Shore A 50 and Shore D 50.

10. The pipe system according to claim 1, wherein the outer casing has a weldable plastic material.

11. The pipe system according to claim 1, wherein the outer casing has an additive crosslinkable by irradiation.

12. The pipe system according to claim 1, wherein at least one additional outer layer is arranged on the outer casing.

13. The pipe system according to claim 1, further comprising a coupling element connected to the conducting element,
wherein the coupling element has an inner component and a coating, and
wherein a material composition of the coating corresponds to a material composition of the outer casing.

14. The pipe system according to claim 13, wherein the inner component is welded to the inner pipe and the coating is welded to the outer casing.

15. A method of forming a pipe connection system, comprising:
forming a conducting element by inserting an outer casing over an inner pipe;
wherein the inner pipe and the outer casing respectively comprise a plastic, and wherein the outer casing has a flame protection durability of 3 minutes at 600° C. and of 2 minutes at 800° C.

16. The method according to claim 15, wherein the inner pipe and the outer casing are not positively connected.

17. The method according to claim 15, further comprising:
forming a coupling element having an inner component and a coating; and
connecting the coupling element to the conducting element.

18. The method according to claim 17, wherein a material composition of the coating corresponds to a material composition of the outer casing.

19. The method according to claim 17, wherein the connecting of the coupling element to the conducting element comprises welding the inner component to the inner pipe and welding the coating is welded to the outer casing.

20. The method according to claim 15, wherein the plastic of the outer casing comprises an amorphous polymer material.
